(19) United States
(12) Patent Application Publication
(10) Pub. No.: US 2005/0118882 A1
(43) Pub. Date: Jun. 2, 2005

(54) Electrical connector latching apparatus

(76) Inventors: Shu Man Chiang, Tucheng City (TW); Chung-Hsin Huang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/723,686

(22) Filed: Nov. 28, 2003

(51) Int. Cl. H01R 13/627

(52) U.S. Cl. 439/680

(57) ABSTRACT

An electrical connector latching apparatus comprises a supporting arm, a latching pivot formed at top portion of the supporting arm, an elastic arm formed at lower portion of the supporting arm, a base arm extending from the lower portion of the elastic arm and a free contact extending vertically from the base arm. A smooth curved surface forms at top portion of the latching pivot and a fixed support portion forms at bottom portion of the latching pivot. The smooth curved surface consists of at least two surfaces having different curvature, thereby the latching pivot slides into a pivot hole of the mated connector neatly. The latching pivot has an indentation-curved surface at its bottom to define the fixed support portion. An angle between the fixed support portion and the supporting arm is a special angle, so that the fixed support portion latches a mated connector firmly. Further the electrical connector contacts with the mated connector electrically and reliably.

### BACKGROUND OF THE INVENTION

1. Field of the Invention

The present invention relates generally to a latching apparatus, and more particularly to an electrical connector latching apparatus capable of assuring a reliable and firm electrical contact there-between.

2. The Prior Art

At present, an electrical connector is coupled with a mated connector by a latching apparatus. A conventional electrical connector latching apparatus is shown in FIG. 7 and FIG. 8. The electrical connector 10a has an insulation cover 1a, which has a plurality of spring terminals 2a and a latch 3a. The latch 3a includes a latching member 31a, a pivot part 32a formed at one end of the latching member 31a and an S-shaped spring part 33a formed at the other end of latching member 31a. The spring part 33a extends to form a pedestal 34a. The pedestal 34a has a saw-toothed part 341a so as to make the latch 3a fasten to the insulation cover 1a.

In general, the electrical connector 10a can be coupled with a mated connector firmly by the latch 3a. The pivot part 32a of the latch 3a couples with the mated connector. Since an outer side of the pivot part 32a is a flat surface, there is a big friction force when latching. Therefore, the latch 3a cannot latch the mated connector smoothly. Furthermore, if an angle formed between the pivot part 32a and the latching member 31a is a right angle (90 degrees) or an obtuse angle (above 100 degrees), the electrical connector 10a departs from the mated connector easily. Consequently, the fixing force between the pivot part 32a and the mated connector is insufficient. Once the electrical connector 10a and the mated connector slip off from each other, the transmission of electrical signal is broken off. On the other hand, if the angle is less than 90 degrees (an acute angle), it overcomes the drawbacks said above, but it makes the electrical connector 10a difficult to depart from the mated connector.

### SUMMARY OF THE INVENTION

According to the present invention, one object of the present inventions is to provide an electrical connector latching apparatus, which is capable of coupling an electrical connector with a mated connector firmly and departing from each other easily.

An electrical connector latching apparatus has a supporting arm. A latching pivot forms at top portion of the supporting arm. A smooth curved surface forms at top portion of the latching pivot. The smooth curved surface consists of at least two surfaces having different curvature; therefore, the latching pivot slides into a pivot hole of the mated connector neatly.

Another object of the present invention is to provide an electrical connector latching apparatus having a latching pivot. The bottom surface of the latching pivot is an indentation-curved surface to define a fixed support portion. An angle between the fixed support portion and the supporting arm is a special angle. Hence, the fixed support portion makes the latching pivot fasten to the mated connector firmly and provides an appropriate force to prevent the joined connectors departing.

As mentioned above, the present invention will now be described more specifically with reference to the drawings attached by the way of examples. And it provides a reliable coupling performance of the electrical connector.

### BRIEF DESCRIPTION OF THE DRAWINGS

A detailed explanation of a preferred embodiment of the present invention will be given, with reference to the attached drawings, for better understanding thereof to those skilled in the art, in which:

FIG. 1 is a partial exploded view of an electrical connector according to the present invention;

FIG. 2 is a perspective view of a latching apparatus according to the present invention;

FIG. 3 is a perspective view of the electrical connector according to the present invention;

FIG. 4 is a cross-sectional view of the electrical connector according to the present invention;

FIG. 5 is a perspective view showing an electrical connector and a mated connector separated;

FIG. 6 is a perspective view showing the electrical connector and the mated connector latched;

FIG. 7 is a partial exploded view of an electrical connector in accordance with the prior art; and

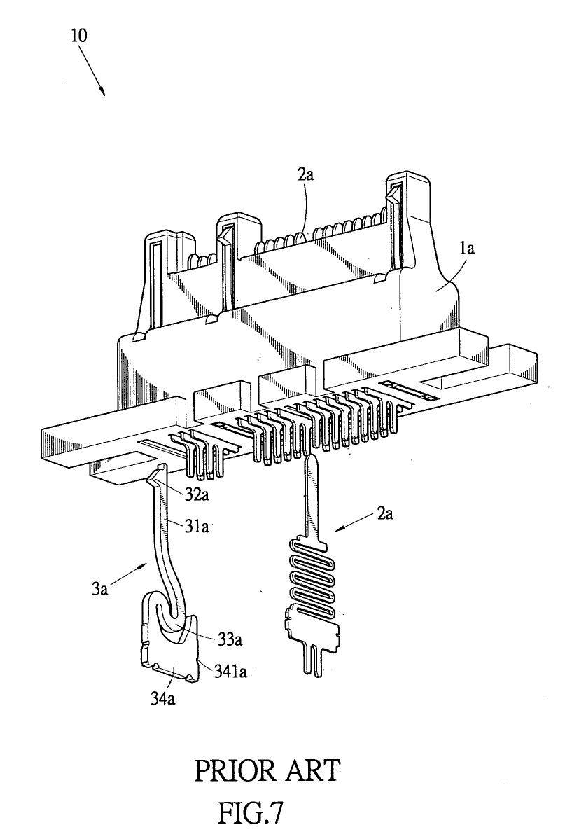

FIG. 8 is a perspective view of an electrical connector latching apparatus in accordance with the prior art.

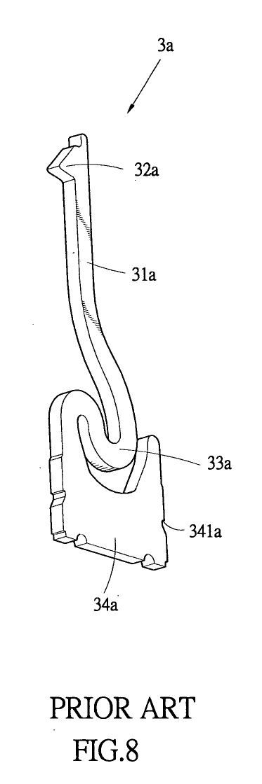

### DETAILED DESCRIPTION OF THE PREFERRED EMBODIMENT

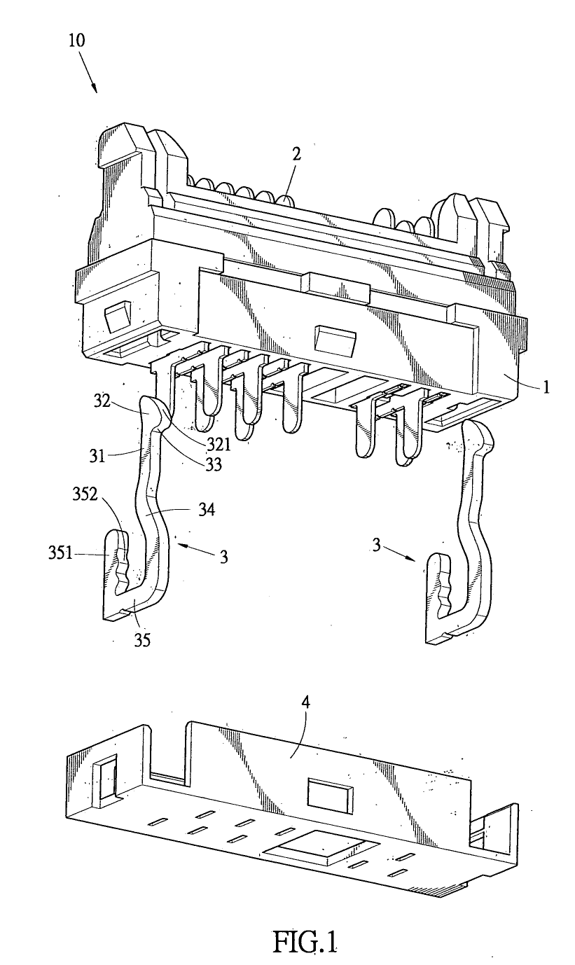

Referring now to FIG. 1, an electrical connector 10 is installed on a baseboard or connected with electrical cables. The electrical connector 10 has an insulation housing 1, a plurality of elastic contacts 2 and a latching apparatus 3. There are two latching apparatus 3 shown in the FIG. 1. A shield housing 4 is latched to the bottom of the electrical connector 10. When the electrical connector 10 couples with a mated connector 20 entirely and contacts conductively, the electrical signal is transmitted by the elastic contacts 2.

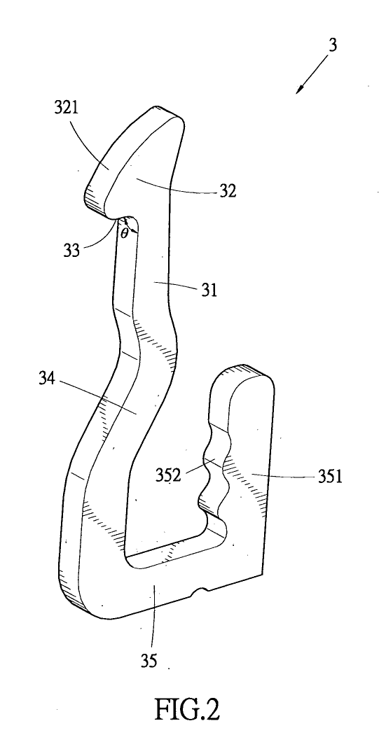

As shown in FIG. 2, according to the present invention, the latching apparatus 3 comprises a supporting arm 31, a latching pivot 32 formed at top portion of the supporting arm 31, an elastic arm 34 extending from the lower portion of the supporting arm 31, a base arm 35 horizontally extending from the lower portion of the elastic arm 34 and a free contact 351 vertically extending from the end of the base arm 35. The latching pivot 32 forms a smooth curved surface 321 at top portion. The smooth curved surface 321 is consisted of at least two surfaces having different curvature. Moreover, a fixed support portion 33 formed at bottom portion of the latching pivot 32. The fixed support portion 33 has an indentation-curved surface to provide friction. An angle θ between the fixed support portion 33 and the supporting arm 31 is approximately from 93 degrees to 100 degrees for smoothly latching and providing suitable fixing force.

The supporting arm 31 inclines and extends towards the bottom thereby to define the elastic arm 34. The elastic arm 34 extends to form the U-shaped base arm 35. An end of the base arm 35 extends vertically to form the free contact 351. The free contact 351 is formed with a plurality of saw-toothed portions 352 on its inside surface to make the latching apparatus 3 couple with the insulation housing 1 of the electrical connector 10 firmly.

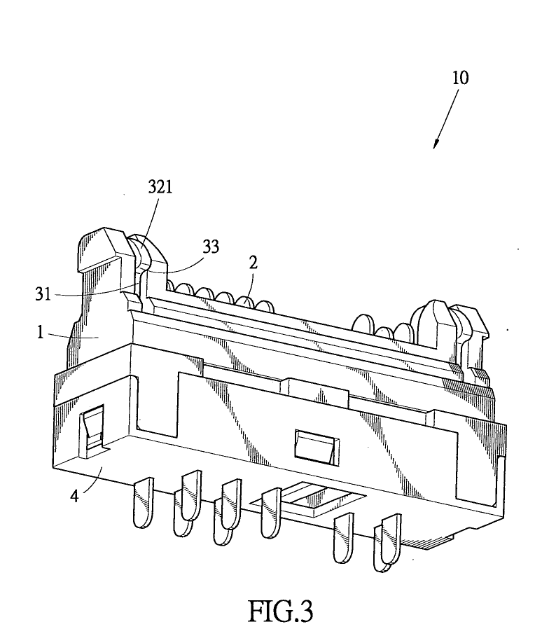

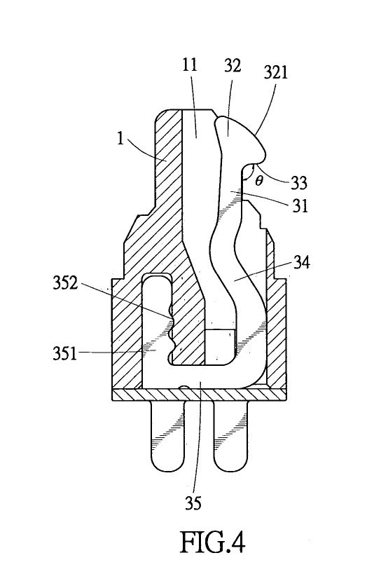

Referring to FIG. 3 and FIG. 4, according to the present invention, the insulation housing 1 of the electrical connector 10 has at least a chamber 11 to receive the latching apparatus 3. The chamber 11 and the latching apparatus 3 have approximate shapes, and the chamber 11 is capable of holding the latching apparatus 3. After the latching apparatus 3 is located in the chamber 11, the latching pivot 32 projects outside. However, the chamber 11 has enough space to allow the supporting arm 31 and the elastic arm 34 moving in the chamber 11. Due to the saw-toothed portion 352, the free contact 351 of the base arm 35 couples with the inside insulation housing 1 stably.

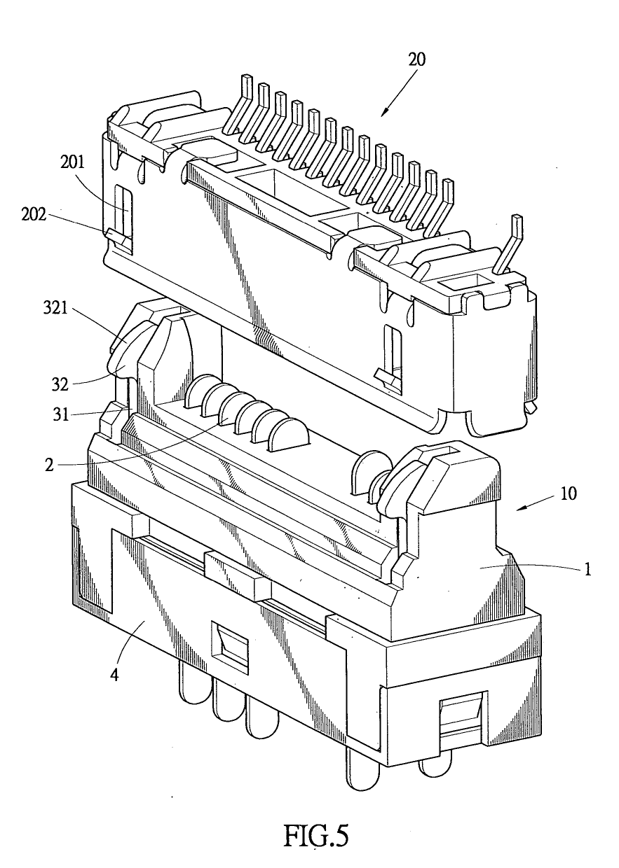

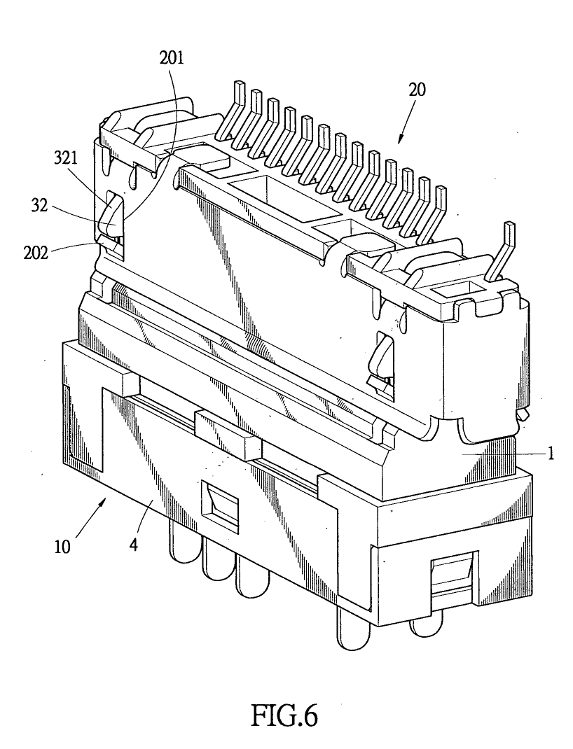

As show in FIG. 5, according to the present invention, the mated electrical connector 20 has a pivot hole 201 corresponding to the latching pivot 32 of the latching apparatus 3. The pivot hole 201 has a blockade board 202 at its bottom. Therefore, when the electrical connector 10 couples with the mated connector 20, the latching pivot 32 is jammed in the corresponding pivot hole 201 of the mated electrical connector 20. The fixed support portion 33 clips to the blockade board 202 of the latching pivot 201. Thus the electrical connector 10 and the mated connector 20 couple together firmly, as shown in FIG. 6.

In accordance with the present invention, when the latching pivot 32 of the latching apparatus 3 slides into the corresponding pivot hole 201, since the top portion of the latching pivot 32 is the smooth curved surface 321, the latching pivot 32 slides into the latching pivot hole 201 lightly and conveniently. Furthermore, the fixed support portion 33 clips to the blockade board 202 of the pivot hole 201, since the angle θ between the fixed support portion 33 and the supporting arm 31 is a special angle, the fixed support portion 33 latches the pivot hole 201 of the mated electrical connector 20 firmly. However, the fixed support portion 33 can be departed from the blockade board 202 easily by a suitable and light pulling force.

Although a particular embodiment of the invention has been described in detail for purposes of illustration, additional advantages and modifications will readily appear to those skilled in the present invention, and various modifications and enhancements may be made without departing from the spirit and scope of the invention. Accordingly, the invention is not to be limited except as by the appended claims.

1. An electrical connector latching apparatus for coupling an electrical connector with a mated electrical connector, the latching apparatus comprising:
a supporting arm;
a latching pivot formed at top portion of the supporting arm, a curved surface formed at top portion of the latching pivot and a fixed support portion formed at bottom portion of the latching pivot, the curved surface being consisted of at least two surface, the fixed support portion having an indentation-curved surface;
an elastic arm extending from the lower portion of the supporting arm;
a base arm extending from the lower portion of the elastic arm; and
a free contact extending from the end of the base arm, the free contact being formed with a plurality of saw-toothed portions on inside surface.

2. The electrical connector latching apparatus as claimed in claim 1, wherein said the electrical connector has a pair of latching apparatus on both laterals.

3. The electrical connector latching apparatus as claimed in claim 1, wherein an angle between the fixed support portion and the supporting arm is from 93 degrees to 100 degrees.
